(19) United States
(12) Patent Application Publication
(10) Pub. No.: US 2011/0315620 A1
(43) Pub. Date: Dec. 29, 2011

(54) COLANDERMATE SYSTEM

(76) Inventor: Susie Dove, Asheville, NC (US)

(21) Appl. No.: 12/825,875

(22) Filed: Jun. 29, 2010

(51) Int. Cl. B01D 35/28

(52) U.S. Cl. 210/232

(57) ABSTRACT

A byproducts handling apparatus is provided having a solid bowl, a trap holder, and a colander. The colander has a plurality of apertures and the solid bowl, the trap holder, and the colander are configured to be assembled together with one another in an assembled condition of the byproducts handling apparatus with the trap holder having a diameter configured in correspondence with both an interior volume of the solid bowl and an outer peripheral dimension of the colander such that the trap holder is disposable between the solid bowl and the colander. The colander is operable to retain an edible product therein such that byproducts released from the edible product exit the colander via the apertures and the trap holder is operable to capture and retain byproducts that have exited the colander and is removable from the byproducts handling apparatus to permit disposal of retained byproducts.

### BACKGROUND OF THE INVENTION

The present invention relates to a system for conveniently and hygienically separating and collecting grease or fat from a food product and a method for using the system.

According to U.S. Pat. No. 5,322,196 to Burton, excess cooking oil sometimes accumulates due to a variety of reasons, and this patent therefore suggests that a container is desirable that may refrigerate, heat, and store cooking oil to avoid waste. After refrigeration, hardened grease can be discarded with proper disposal. The container can be washed and stored for further use. U.S. Pat. No. 5,322,196 to Burton further notes that several types of products that filter and collect grease for storage are known and refers to U.S. Pat. No. 4,555,339 to Graves, which discloses an inner disposable container within an outer one that has two lids and U.S. Pat. No. 4,040,964 to Heguyi, which discloses a strainer and handle that is adjustable to a container. However, according to U.S. Pat. No. 5,322,196 to Burton, one must obtain a container that will withstand hot cooking oil, and not deform the shape of the pot when pouring, while this same container configuration must nonetheless be able to refrigerate grease and store it at room temperature.

While devices are known for straining byproducts from foodstuffs during the course of preparing these foodstuffs for consumption, there continues to be a need for a system that further increases the convenience of separating such byproducts from foodstuffs as well as increases the convenience of handling and disposing of the byproducts such as grease or fat once such byproducts have been separated from a foodstuff. Moreover, there continues to be need for a system that is particularly suitable for separating grease and fat byproducts from cooked meat, such as cooked ground beef, and for handling and disposing of these byproducts.

### SUMMARY OF THE INVENTION

It is therefore an object of the present invention to provide a new apparatus for promoting the release of grease and fat from edible products and for collecting such grease and fat as well a new method which offer advantages over known grease and fat release and collection devices.

It is an object of the present invention to provide a new apparatus for promoting the release of grease and fat from edible products and for collecting such grease and fat having a high durability and that can be used repeatedly without a need for frequent maintenance.

An even further object of the present invention is to provide a new apparatus for promoting the release of grease and fat from edible products and for collecting such grease and fat that is convenient to use and which provides a convenient grease and fat retaining component that can be readily separated from other components of the apparatus

Yet another object of the present invention is to provide a new apparatus for promoting the release of grease and fat from edible products and for collecting such grease and fat having a trap holder that can be disposed with its base resting upon the base of a solid bowl and in which a colander can be positioned with its rim supported upon a top ledge of the solid bowl.

### BRIEF DESCRIPTION OF THE DRAWINGS

FIG. 1 is a sectional front elevational view of one embodiment of the byproducts handling apparatus of the present invention;

FIG. 2 is an exploded elevational view of the one embodiment of the byproducts handling apparatus shown in FIG. 1;

FIG. 3 is a top perspective view of the colander of the one embodiment of the byproducts handling apparatus shown in FIGS. 1 and 2;

FIG. 4 is a top plan view of the colander shown in FIG. 3;

FIG. 5 is a sectional front elevational view of another embodiment of the byproducts handling apparatus of the present invention;

FIG. 6 is an exploded elevational view, in partial section, of another embodiment of the byproducts handling apparatus shown in FIG. 5;

FIG. 7 is an enlarged perspective view of a portion of the trap holder of another embodiment of the byproducts handling apparatus shown in FIGS. 5 and 6;

FIG. 8 is a side elevational view of the colander of the one embodiment of the byproducts handling apparatus shown in FIGS. 1 and 2;

FIG. 9 is a sectional front elevational view of a further embodiment of the byproducts handling apparatus of the present invention;

FIG. 10 is a top plan view of the colander shown in FIG. 3, showing dimensions of the colander;

FIG. 11 is a front elevational view of the colander of the one embodiment of the byproducts handling apparatus shown in FIGS. 1 and 2;

FIG. 12 is a sectional front elevational view of the colander of the one embodiment of the byproducts handling apparatus shown in FIGS. 1 and 2;

FIG. 13 is a front sectional view of the solid bowl of the one embodiment of the byproducts handling apparatus shown in FIGS. 1 and 2; and

FIG. 14 is a top view of the solid bowl of the one embodiment of the byproducts handling apparatus shown in FIGS. 1 and 2.

### DETAILED DESCRIPTION OF AN EMBODIMENT

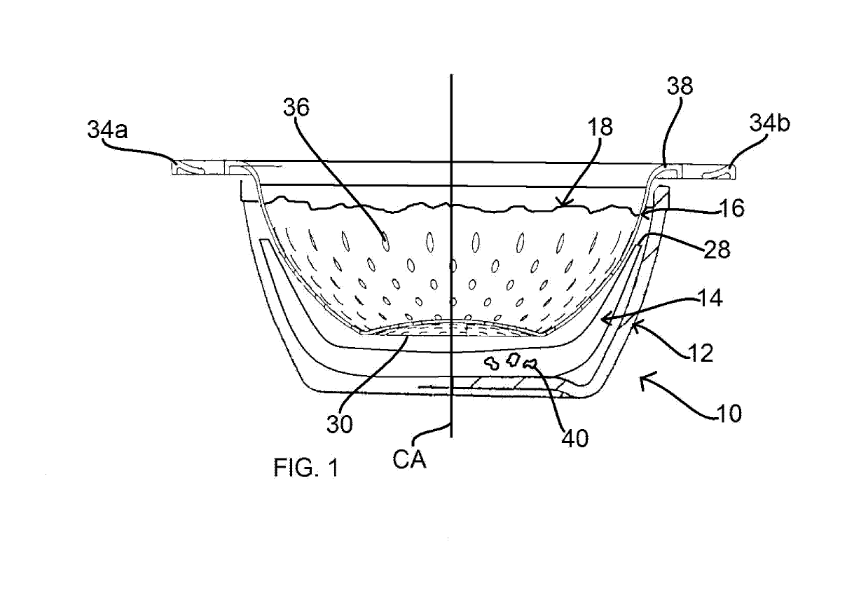

With reference now to FIGS. 1-4 and 8-14, one embodiment of the byproducts handling apparatus of the present invention will now be described. The byproducts handling apparatus, generally designated as the byproducts handling apparatus 10, includes a solid bowl 12, a trap holder 14, and a colander 16. The byproducts handling apparatus 10 is operable to receive an edible product that may or may not have previously been subjected to a heat treatment such as, for example, braising, frying, browning, or searing, and is operable to conveniently and automatically effect a separation of selected byproducts such as grease or fat from the edible product. The edible product, which may be, for example, a quantity of cooked meat 18 as shown in FIG. 1, is a “foodstuff” that has not yet been disposed into a ready-to-serve condition—that is, the foodstuff has not yet, for example, been placed into standard portion sizes for human or animal consumption. Accordingly, it can be understood that the byproducts handling apparatus 10 is capable of receiving any suitable edible product such as a meat-, fowl-, or seafood-based foodstuff, a plant-based foodstuff, or a hybrid foodstuff formed, for example, of a meat-based foodstuff and a plant-based foodstuff combined together.

The byproducts handling apparatus 10 can be provided with additional features that facilitate the handling and processing of the cooked meat 18 including, for example, carry handles and footing elements for stably supporting the byproducts handling apparatus 10 on a suitable surface such as, for example, a countertop surface of a kitchen of a home or a restaurant. However, it is to be understood that the byproducts handling apparatus 10, in its basic form, is operable to perform its intended purpose via the interrelated operation of the solid bowl 12, the trap holder 14 and the colander 16, as will be described in more detail hereinafter.

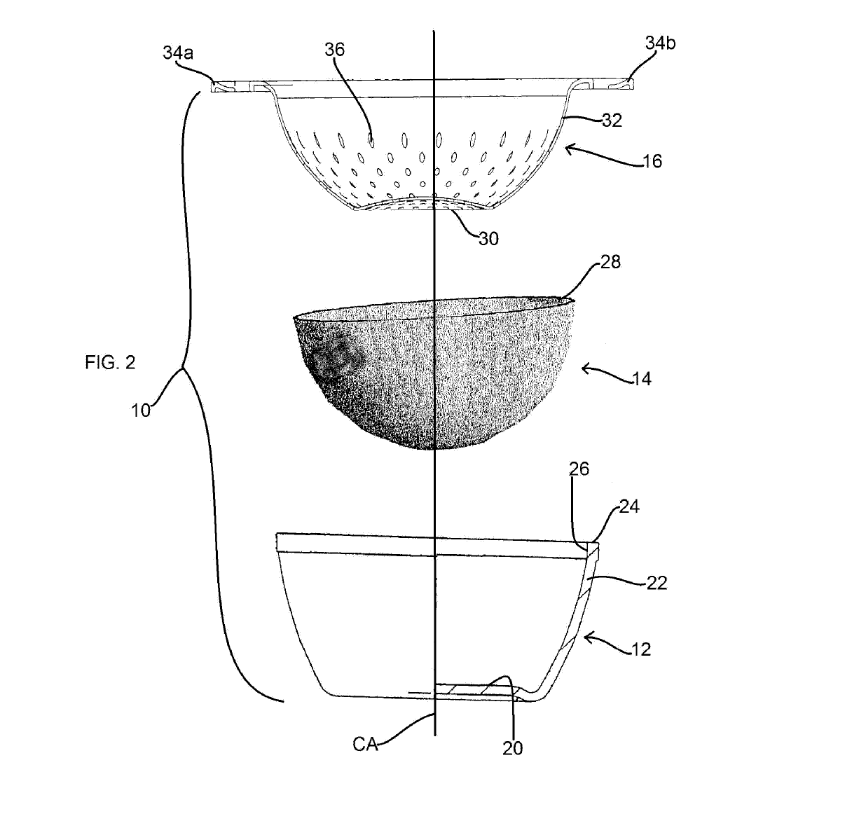

As seen in FIGS. 1 and 2, the solid bowl 12 is configured as an open top container having a base 20 and a side wall 22 connected to the entire periphery of the base 20 in a leak proof manner and extending vertically from the base 20. The side wall 22 forms a top ledge 24 that delimits an opening 26 through which the trap holder 14 and a portion of the colander 16 can be inserted into an interior volume of the solid bowl 12. The solid bowl 12 can be formed, for example, of a ceramic material, a metal or metal alloy, stainless steel, a polymer material, plastic, or rubber, and is configured of a suitable material strength and geometric configuration such that the side wall 22 of the solid bowl 12 is “self-standing” when the base 20 is supported on a horizontal surface such as a countertop surface—that is, the side wall 22 extends vertically from the base 20 and maintains the top ledge 24 at a predetermined height above the horizontal surface on which the solid bowl 12 is positioned without the need for another structure to support the side wall 22 in its vertical position.

The trap holder 14, which is shown in FIGS. 1 and 2, is operable to receive and retain byproducts such as grease and fat that have exited the colander 16. The capability of the trap holder 14 to receive and retain such byproducts is imparted by suitably configuring the trap holder 14 with a suitable material or materials, a suitable geometric configuration, and a suitable size and volume of the trap holder relative to the solid bowl 12 and the colander 16, and further by suitable selection of these characteristics such that the trap holder 14 can perform its functions over the given range of time over which the trap holder 14 will be required to receive and retain byproducts. The trap holder 14 of the one embodiment of the byproducts handling apparatus 10 is formed of a coated paper-based material and has a geometrical configuration in the shape of one-half of a sphere, with the largest diameter portion of the trap holder 14 being delimited by an upper edge 28.

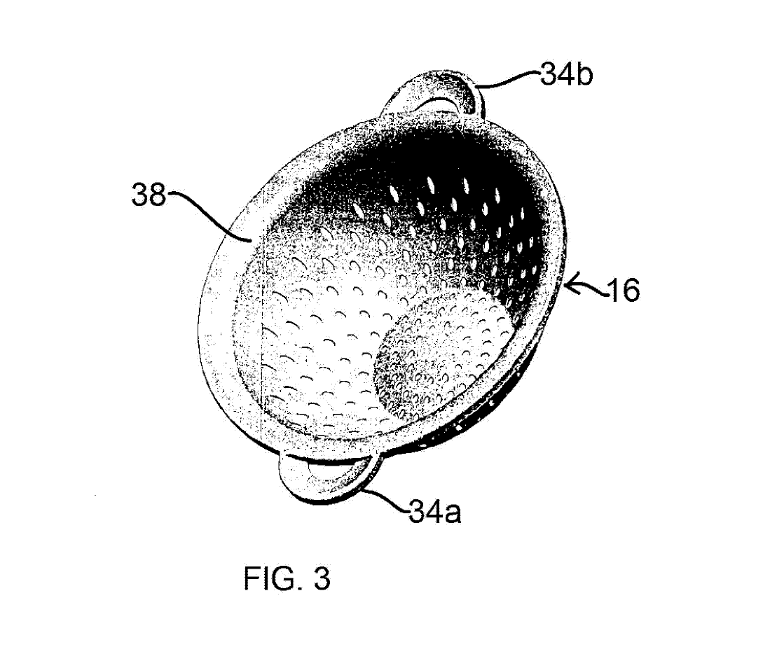

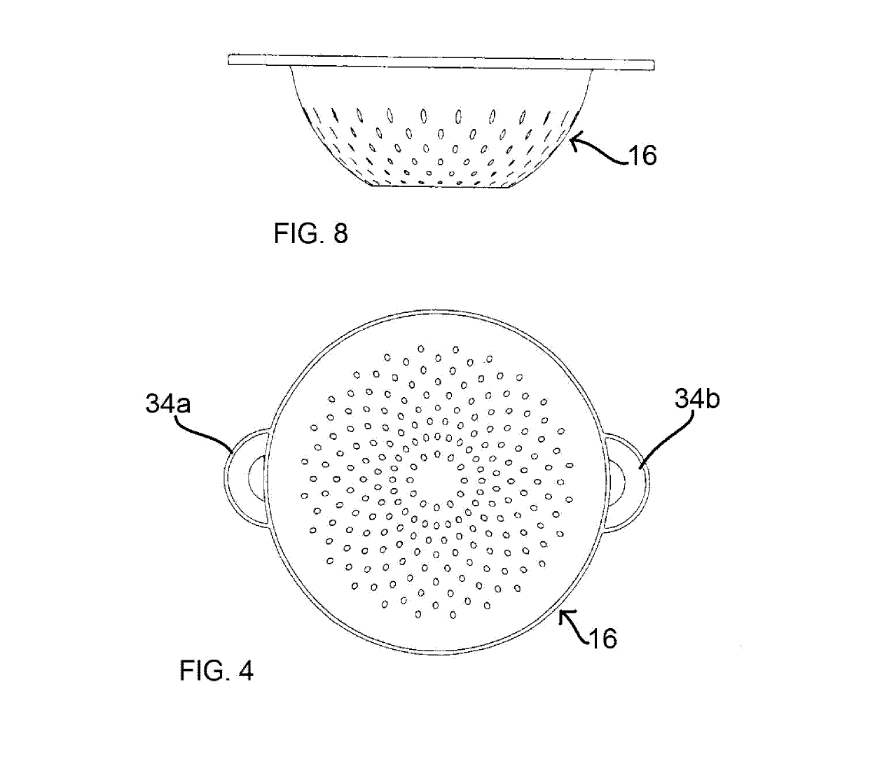

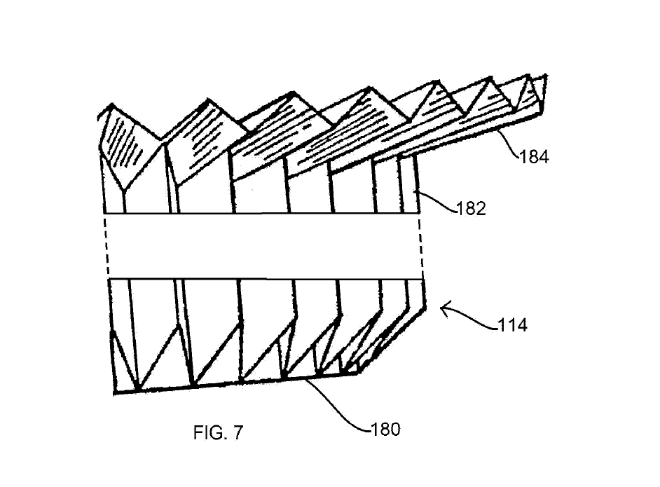

The colander 16 of the one embodiment of the byproducts handling apparatus 10 is shown in the assembled condition of the byproducts handling apparatus 10 in FIG. 1, in an exploded manner of the byproducts handling apparatus 10 in FIG. 2, in a top perspective view in FIG. 3, in a top plan view in FIG. 4, and in a side elevational view in FIG. 8. The colander 16 has a base 30, a side wall 32 connected to the entire periphery of the base 30 in a continuous manner and extending vertically from the base 30, and a pair of handles 34a, 34b. The colander 16 is formed of a material strength and a geometric configuration that provides the colander 16 with the capability to receive and retain an edible product such as, for example, a quantity of cooked meat 18 as shown in FIG. 1. The colander 16 is provided with a plurality of apertures 36 distributed in the side wall 32 and in the base 30. The apertures 36 can be configured in a repeating pattern or can be randomly distributed and the cross-sectional size of the apertures 36 can be variable—i.e., one group of the apertures 36 along one portion of the side wall 32 of the colander 16 can be formed with larger individual cross-sectional areas than another group of the apertures 36 formed in the base 30. The apertures 36 operate as conduits through which byproducts such as grease or fat of an edible product such as the cooked meat 18 pass through a respective one of the side wall 32 or the base 30 of the colander 16, and these byproducts that have passed through the apertures 36 thereafter travel, in a manner to be described in more detail, away from the colander 16 to ultimately be captured and retained by the trap holder 14.

As seen in FIGS. 1-3, each of the handles 34a, 34b of the colander 16 projects radially outwardly from a rim 38 that delimits the largest diameter of the colander 16. The rim 38 has an inner diameter less than the inner diameter of the top ledge 24 of the solid bowl 12 and preferably has an outer diameter at least equal to the outer diameter of the top ledge 24 of the solid bowl 12 and, preferably greater than the outer diameter of the top ledge 24 of the solid bowl 12. With reference now to FIG. 1, which is a sectional front elevational view of the byproducts handling apparatus 10, and to FIG. 2, which is an exploded front elevational view, in partial section, of the byproducts handling apparatus 10, the disposition of the solid bowl 12, the trap holder 14, and the colander 16 relative to one another in an assembled condition of byproducts handling apparatus 10 will now be described. The trap holder 14 has a diameter configured in correspondence with both the interior volume of the solid bowl 12 and an outer peripheral dimension of the colander 16 such that the trap holder 14 is disposable between the solid bowl 12 and the colander 16 in a predetermined manner. In particular, with reference to a centering axis CA that extends perpendicularly to the base 20 of the solid bowl 12 through the midpoint of a circle delimited by the top ledge 24 of the solid bowl 12, the semi-spherical shape of the trap holder 14 is configured such that the nadir, or lowest point, of the semi-spherical geometry of the trap holder 14 is intersected by the centering axis CA when the trap holder 14 is disposed in the interior volume of the solid bowl 12. Additionally, as best seen in FIG. 1, the diameter of the trap holder 14 is configured such that the outer surface of the trap holder 14 is disposed radially inwardly from the inner surface of the side wall 22 of the solid bowl 12 and the diameter of the trap holder 14 is further configured such that the upper edge 28 of the trap holder does not extend above the top ledge 24 of the solid bowl 12, as measured relative to the centering axis CA.

The geometry of the outer surface of the side wall 32 of the colander 16 is configured such that this outer surface of the side wall is at a predetermined spacing radially inwardly from the inner surface of both the trap holder 14 and the inner surface of the side wall 22 of the solid bowl 12 in the assembled condition of the byproducts handling apparatus 10. Additionally, the dimensions and configuration of the base 30 of the colander 16 are such that this base 30 is at an axially spacing from the inner surface of the trap holder 14 in the assembled condition of the byproducts handling apparatus 10. The side wall 32 and the base 30 of the colander 16 are maintained at their respective spacings from the trap holder 14 and the solid bowl 12 via the configuration of the rim 38 of the colander 16 such that this rim 38 is disposed upon the top ledge 24 of the solid bowl 12 in the assembled condition of the byproducts handling apparatus 10. The support of the rim 38 of the colander 16 on the top ledge 24 of the solid bowl 12 ensures that the base 30 of the colander 16 is maintained at an axial spacing above the inner surface of the trap holder 14. The radial spacing of the side wall 32 of the colander 16 from the inner surface of the trap holder 14 is achieved by approximate or exact centering of the colander 16 on the centering axis CA, taking into account that the combined mass of the colander 16 and the edible product therein (such as the cooked meat 18) will exert a downward force onto the top ledge 24 of the solid bowl 12 (applied through the rim 38 of the colander 16). As seen in FIG. 1, the handles 34a, 34b of the colander 16 project radially outwardly from the solid bowl 12 in diametrically opposition to one another.

With the byproducts handling apparatus 10 in its assembled condition shown in FIG. 1, in which the trap holder 14 has been disposed with its base resting upon the base 20 of the solid bowl 12 and in which the colander 16 has been positioned with its rim 38 supported upon the top ledge 24 of the solid bowl 12, the byproducts handling apparatus 10 is ready to receive an edible product such as the cooked meat 18 for a number of further handling steps including the further handling step of effecting the release of byproducts such as grease or fat from the cooked meat 18. The cooked meat 18 can, as desired, already be retained within the colander 16 before the positioning of the colander 16 relative to the trap holder 14 and the solid bowl 12, or, alternatively, the cooked meat 18 can be disposed within the colander 16 after the colander 16, the trap holder 14, and the solid bowl 12 have been assembled with one another. Byproducts such as grease or fat contained in the cooked meat 18 are expressed or expelled out of the cooked meat 18, and this grease or fat that has been expressed or expelled out of the cooked meat 18 eventually reaches the apertures 36 within the colander 16 due to the force of gravity, capillary action, and other fluid transport actions. These byproducts, which are schematically shown as byproduct droplets 40 in FIG. 1, travel in a generally downward direction and are ultimately captured and retained by the trap holder 14. The trap holder 14, due to its upwardly rising side walls, channels the byproduct droplets 40 toward the lowermost point of the trap holder 14. In the event that the trap holder 14 is comprised of an absorbent structure, this absorbent structure may absorb some portion or all of the byproduct droplets 40. Alternatively, if the trap holder 14 does not comprise an absorbent structure that is in contact with the byproduct droplets 40, or if the trap holder 14 comprises an absorbent structure of limited absorbency, a pool of the byproduct droplets 40 may form generally at the lowest point of the trap holder 14. It can be understood that the axial spacing of the base 30 of the colander 16 with respect to the trap holder 14 is preferably such that the depth, or axial dimension, of such a pool of the byproduct droplets 40 is of a limited extent to thereby ensure that the byproduct droplets 40 are not in contact with the base 30 of the colander 16.

The fluid transport movement of the byproduct such as grease or fat out of the cooked meat 18 and beyond the colander 16 can be achieved via the sole mechanism of the retention of the cooked meat 18 within the colander 16 or can be facilitated via, for example, the application of a downward pressure on the cooked meat 18. Following the expiration of a predetermined period of time during which byproducts such as grease or fat have exited the colander 16 to be captured by the trap holder 14, a user can lift the colander 16 off of the solid bowl 12 so that the rim 38 of the colander 16 is no longer supported on the top ledge 24 of the solid bowl 12 and, once the user has lifted the colander 16 clear of the top ledge 24 of the solid bowl 12, the user can dispose the colander 16, still retaining therein the cooked meat 18, on a cooking vessel that supports the rim 38 of the colander 16 thereon or, alternatively, the colander 16 can be disposed onto a countertop surface or onto an intermediary structure such as a paper towel resting on a countertop surface. Throughout this lifting off step in which the colander 16 is lifted off the solid bowl 12, the trap holder 14 continues to retain the byproduct droplets 40 that have been captured by the trap holder. With the colander 16 thus no longer disposed above the trap holder 14, the user can lift the trap holder 14 with the retained byproduct droplets 40 therein and the trap holder 14 can be moved as a single unit to, for example, at a location at which the retained byproduct droplets 40 can be poured out of the trap holder 14 (into, for example, a glass or ceramic container) or, alternatively, both the trap holder 14 and the retained byproduct droplets 40 therein can be disposed of as a single unit by, for example, placing the trap holder 14 into a trash container. The solid bowl 12, which no longer supports the trap holder 14 or the colander 16, is now available for use with respect to other tasks such as, for example, retaining edible products such as, for example, fruits, vegetables, or juice.

It can be understood that the one embodiment of the byproducts handling apparatus is particularly suitable for deployment in connection with a method of separating byproducts from an edible product. The method includes the steps of disposing the solid bowl 12 on a horizontal surface, disposing the trap holder 14 in the interior volume of the solid bowl 12, disposing the colander 16 to be supported by the solid bowl 12 with the trap holder 14 disposed intermediate the colander 16 and the solid bowl 12, placing an edible product in the colander 16, collecting byproducts such as grease or fat in the trap holder 14, lifting off the colander 16 from its supported disposition on the solid bowl 12, lifting the trap holder 14 from within the interior volume of the solid bowl 12, and disposing the colander 16 and the trap holder 14 at selected locations. Variations of the method include disposing an edible product in the colander 16 prior to positioning of the colander 16 in its supported disposition on the solid bowl 12, disposing the trap holder 14 relative to the colander 16 in a “solid cupping” manner and thereafter disposing the sub-assembly of the trap holder 14 and the colander 16 into the interior volume of the solid bowl 12, and disposing an edible product in the colander 16 after the colander 16 has been disposed in its supported disposition on the solid bowl 12. Moreover, the method can include suitable additional steps such as, for instance, simultaneously lifting the trap holder 14 and the colander 16 off of the solid bowl 12. An alternative method suitable for use with the one embodiment of the byproducts handling apparatus 10 of the present invention comprises a step of retaining the trap holder 14 within the interior volume of the solid bowl 12 after the trap holder 14 has received byproducts such as grease or fat and tilting the combined sub-unit of the trap holder 14 and the solid bowl 12 relative to a horizontal plane to effect a pouring out of the byproducts retained in the trap holder 14 into, for example, another container or a sink of a kitchen. Another step of this alternative method can be lifting off the trap holder 14 from the solid bowl 12 after a predetermined portion of the retained byproducts have been poured out of the trap holder 14 and then disposing the lifted-off trap holder 14 in, for example, a trash container.

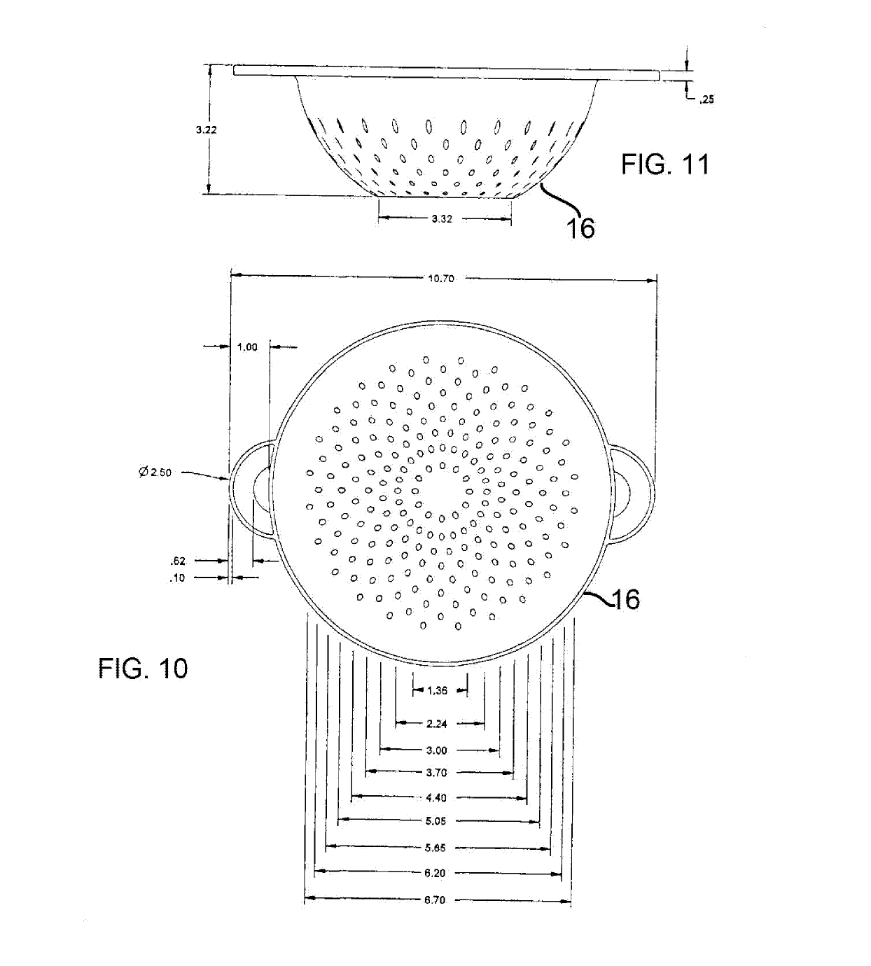

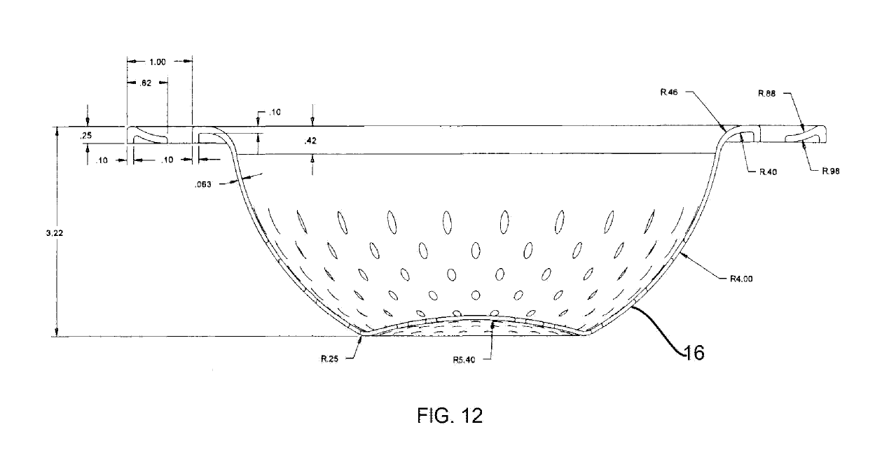

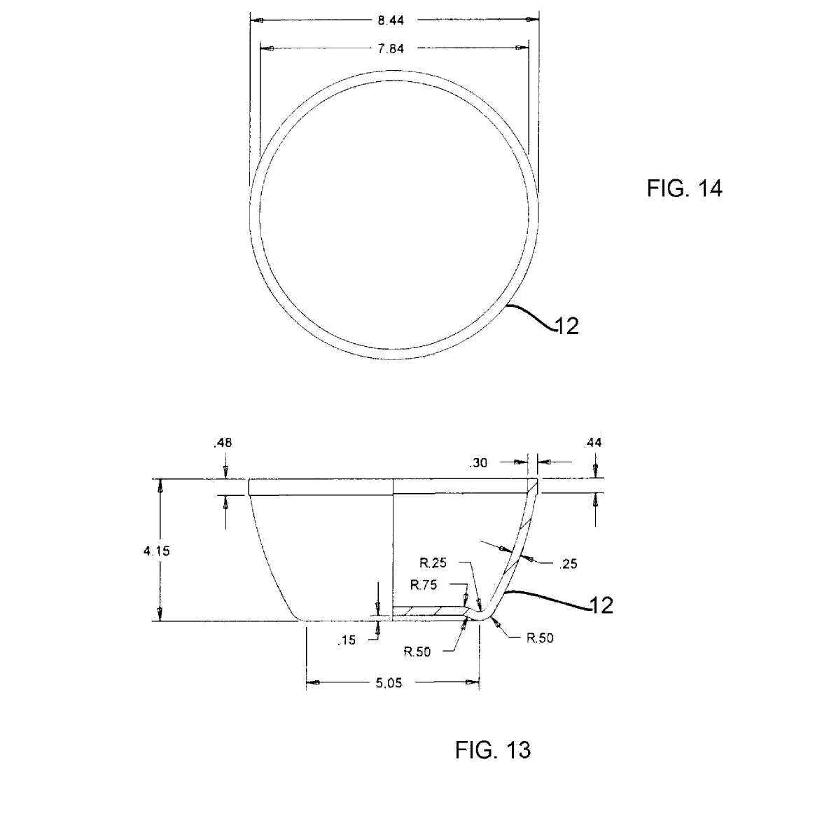

FIGS. 10-12 show various views of the colander 16 of the byproducts handling apparatus 10, with each of these figures of the drawings showing exemplary dimensions of the colander. In this regard, FIG. 10 is a top plan view of the colander, FIG. 11 is a front elevational view of the colander, FIG. 12 is a sectional front elevational view of the colander 16 of the byproducts handling apparatus 10, FIG. 13 is a front sectional view of the solid bowl 12 of the byproducts handling apparatus 10, and FIG. 14 is a top view of the solid bowl 12 of the byproducts handling apparatus 10.

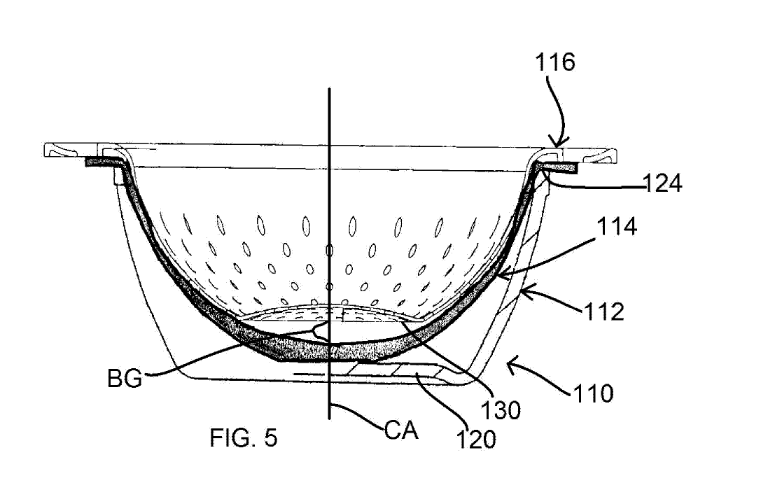

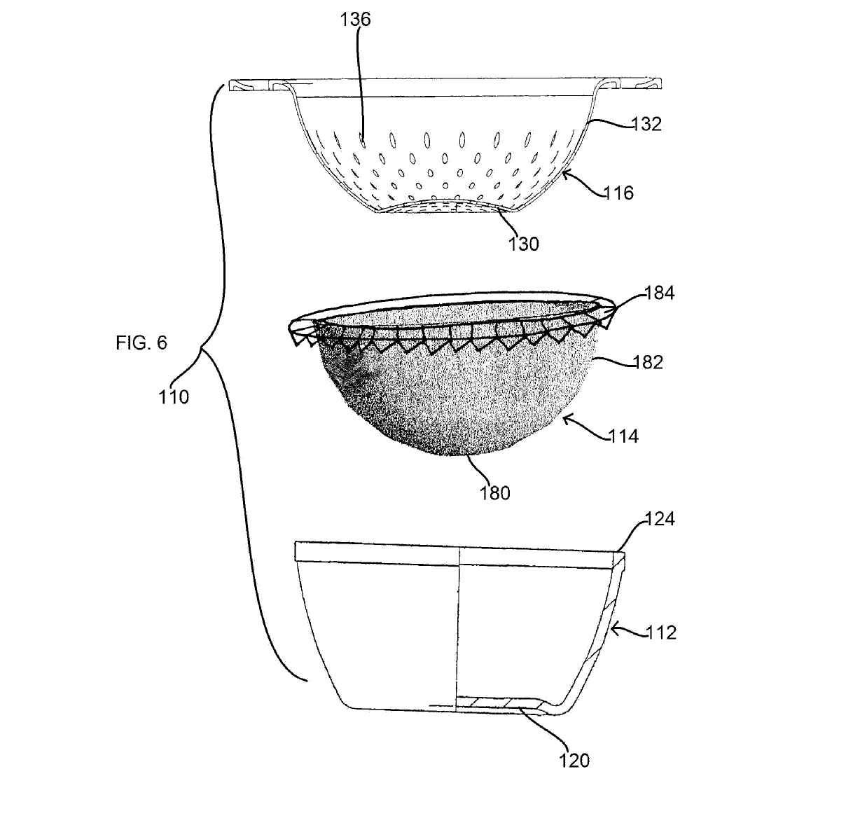

With reference now to FIGS. 5, 6 and 7, another embodiment of the byproducts handling apparatus of the present invention will now be described, and the byproducts handling apparatus, generally designated as the byproducts handling apparatus 110, includes a solid bowl 112, a trap holder 114, and a colander 116. As seen in FIG. 6, which is an exploded front elevational view, in partial section, of the byproducts handling apparatus 110, and FIG. 5, which is a sectional front elevational view of the byproducts handling apparatus 110 in its assembled condition, the colander 116 is provided with a plurality of apertures 136 distributed in a side wall 132 and a base 130 of the colander. The apertures 136 can be configured in a repeating pattern or can be randomly distributed, and the cross-sectional size of the apertures 136 can be variable—i.e., one group of the apertures 136 along one portion of the side wall 132 of the colander 116 can be formed with larger individual cross-sectional areas than another group of the apertures 136 formed in the base 130. The apertures 136 operate as conduits through which byproducts such as grease or fat of an edible product, such as cooked meat 18, pass through.

The trap holder 114 has a geometric configuration configured in correspondence with both the interior volume of the solid bowl 112 and an outer peripheral dimension of the colander 116 such that the trap holder 114 is disposable between the solid bowl 112 and the colander 116 in a predetermined manner. In particular, with reference to a centering axis CA that extends perpendicularly to a base 120 of the solid bowl 112 through the midpoint of a circle delimited by a top ledge 124 of the solid bowl 112, the trap holder 114 has a semi-spherical shape configured such that the nadir, or lowest point, of the semi-spherical trap holder 114 is intersected by the centering axis CA when the trap holder 114 is disposed in the interior volume of the solid bowl 112. As seen in FIG. 7, which is an enlarged perspective view of an arcuate portion of the trap holder 114, the trap holder 114 includes a base 180, a side wall 182 connected at its lower end to the entire periphery of the generally disc-shaped base 180 and an overhang portion 184 extending radially from the top edge of the side wall 182. Both the side wall 182 and the overhang portion 184 are formed in a pleated configuration, and the trap holder 114 is formed, for example, of a reinforced paper product, a cardboard product, a cellulose product, a polymer, or a plastic product.

With reference to FIGS. 5 and 6, it can be seen that the overhang portion 184 of the trap holder 114 is configured to extend radially outwardly over the top ledge 124 of the solid bowl 112 in the assembled condition of the byproducts handling apparatus 110. In the assembled condition of the byproducts handling apparatus 110, the overhang portion 184 of the trap holder 114 is disposed intermediate a top rim of the colander 116 and the top ledge 124 of the solid bowl 112 and is compressively engaged therebetween and, further, the base 180 of the trap holder 114 rests upon an interior surface of the base 120 of the solid bowl 112. The base 130 of the colander 116 is configured with a generally planar overall shape and is configured relative to the trap holder 114 such that, in the assembled condition of the byproducts handling apparatus 110, the base of the colander 116 is at a vertical spacing BG above the trap holder 114. As desired, the side wall 182 of the trap holder 114 can be configured of a geometry and a material strength such that this side wall 182 is “self-standing”—that is, the side wall extends without external support vertically from the base 180 of the trap holder 114, or the side wall 182 can be configured as a non “self-standing” side wall. In the event that the side wall 182 of the trap holder 114 is configured as a non “self-standing” side wall, then the compressive engagement of the overhang portion 184 of the trap holder 114 between the rim of the colander 116 and the top ledge of the solid bowl 112 operates to maintain the side wall 182 of the trap holder 114 in a vertical orientation in the assembled condition of the byproducts handling apparatus 110.

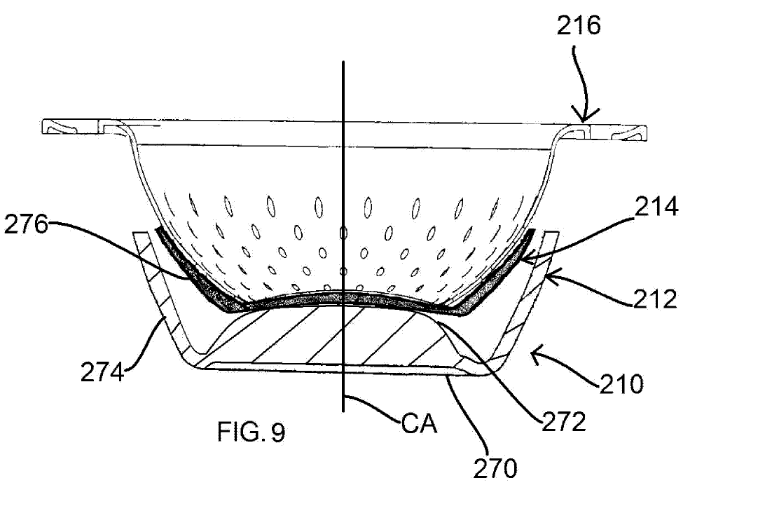

With reference now to FIG. 9, which is a front sectional elevational view of a further embodiment of the byproducts handling apparatus of the present invention, generally designated as the byproducts handling apparatus 210, it can be seen that the byproducts handling apparatus 210 includes a solid bowl 212, a trap holder 214, and a colander 216. The solid bowl 212 includes a base 270 having an inwardly protruding inner surface 272, and the solid bowl 212 includes a rigid side wall 274 extending vertically from the base 270. In the assembled condition of the byproducts handling apparatus 210, the trap holder 214 is disposed with its base intermediate a base of the colander 216 and the inner surface 272 of the base 270 of the solid bowl 212. The trap holder 214 is formed with a side wall 276 of sufficient rigidity to extend vertically from the base of the trap holder in the assembled condition of the byproducts handling apparatus 210. In this embodiment, the combined mass of the colander 216 and the respective edible product such as, for example, the cooked meat 18, retained in the colander 216, is sufficient to exert a downward retaining force on the base of the trap holder 214 that generally maintains the base of the trap holder in its disposition on the inner surface 272 of the base 270 of the solid bowl 212. In operation, once grease or fat has been collected in the trap holder 214, the operator removes the colander 216 and places it aside, then the operator removes the trap holder 214 having the byproduct such as grease or fat retained therein, and as desired, pours off these byproducts or disposes of the retained byproducts and the trap holder 214 as a single unit in, for example, a trash container.

It can therefore be understood that the byproducts handling apparatus of the present invention can be configured as desired to facilitate the convenience of releasing byproducts from an edible product such as, for example, the cooked meat 18, and to facilitate the hygienic and convenient disposal of the byproducts such as fat or grease that have been released from the edible product and are now retained by the colander of the byproducts handling apparatus. While it may be desirable to configure the colander with sufficient rigidity to be “self-standing”, such as has been described and illustrated with respect to the one embodiment of the byproducts handling apparatus 110 shown in FIGS. 1-4 and 8-14, it may be desirable in other circumstances to configure the colander of the byproducts handling apparatus with a side wall having only limited rigidity and, even, a limited rigidity such that the side wall is non “self-standing.” In such circumstances, wherein there is not the need to provide the side wall of the colander with a “self-standing” rigidity, there may be an opportunity to configure the colander with less material than a more rigid colander—i.e., the thickness of the side wall of the colander can have a reduced dimension, or the material properties of the side wall can be imparted by, for example, a treated or untreated paper or cardboard, in contrast to a more rigid material such as a molded plastic.

While an embodiment of the invention has been described and illustrated herein, it is to be distinctly understood that the invention is not limited thereto, but may be otherwise variously embodied and practiced within the scope of the following claims.

It is claimed:

1. A byproducts handling apparatus, comprising:
a solid bowl;
a trap holder; and
a colander, the colander having a plurality of apertures, and
the solid bowl, the trap holder, and the colander being configured to be assembled together with one another in an assembled condition of the byproducts handling apparatus with the trap holder being configured in correspondence with both an interior volume of the solid bowl and the colander such that the trap holder is disposable between the solid bowl and the colander, the colander being operable to retain an edible product therein such that byproducts released from the edible product exit the colander via the apertures and the trap holder being operable to capture and retain byproducts that have exited the colander and being removable from the byproducts handling apparatus to permit disposal of retained byproducts.

2. The byproducts handling apparatus according to claim 1, wherein the solid bowl includes a base and an annular top ledge, the byproducts handling apparatus includes a centering axis that extends perpendicularly to the base of the solid bowl and through the midpoint of a circle delimited by the top ledge of the solid bowl, the trap holder has a semi-spherical shape, and the trap holder is configured such that the nadir, or lowest point, of the trap holder is intersected by the centering axis when the trap holder is disposed in the interior volume of the solid bowl.

3. The byproducts handling apparatus according to claim 2, wherein the trap holder is formed of an absorbent material.

4. The byproducts handling apparatus according to claim 1, wherein the trap holder has a sidewall formed of a pleated configuration.

5. The byproducts handling apparatus according to claim 4, wherein the trap holder includes an overhang portion that is compressively engaged between the colander and the solid bowl in the assembled condition of the byproducts handling apparatus.
